(19) United States
(12) Patent Application Publication
(10) Pub. No.: US 2003/0037687 A1
(43) Pub. Date: Feb. 27, 2003

(54) Sleeve comprising means for fixing printing plates and method for making same

(76) Inventor: Laurent Aubanel, Guebwiller (FR)

Correspondence Address: LADAS & PARRY, 26 WEST 61ST STREET, NEW YORK, NY, 10023, US

(21) Appl. No.: 10/148,950

(22) PCT Filed: Dec. 11, 2000
(86) PCT No.: PCT/FR00/03611

(51) Int. Cl. B41F 27/00

(52) U.S. Cl. 101/382.1

(57) ABSTRACT

The invention concerns an endless sleeve comprising at least a substantially cylindrical support and whereof the outer surface is coated with at least a layer of bonding and permanently adhesive material. Said sleeve is designed to be mounted on a support cylinder, while its outer surface enables printing plates to be removably fixed by adhesion. The invention is applicable for flexographic printing.

The invention relates to the art of printing and more particularly to the fixation of printing plates or masters to support cylinders of printing machines or to sleeves provided on these cylinders.

It is known that such printing plates are used in particular for flexographic printing.

Usually these printing plates comprise a photopolymer layer deposited on a support. Before the printing plate is used, the photopolymer layer is developed to obtain a layer with relief patterns, with which the image to be printed can be reproduced.

Printing plates are generally reused several times. It is therefore desirable to have fixation means that hold the plates effectively during printing but permit their removal from the plateholder cylinder or from the sleeve fixed to the cylinder for the purpose of later reuse.

Known means for fixation of printing plates comprise double-sided adhesive tapes.

Each adhesive tape is fixed by one adhesive side directly to the plateholder cylinder or to a sleeve fixed on the cylinder, while one or more printing plates is or are fixed to the other side of the tape.

These double-sided adhesives suffer from numerous disadvantages.

Firstly, part of the adhesive remains fixed to the printing plate after it has been removed from the cylinder or from the sleeve fixed to the cylinder. It is then necessary to clean the plate to remove the residual adhesive before any new use of the plate.

In addition, the use of double-sided adhesive is costly in view of the price of the adhesive itself and of the operations that it necessitates.

The object of the invention is to alleviate these disadvantages by proposing a sleeve intended to be fixed to a cylinder and provided with means for fixing printing plates that can be manufactured simply and have a low cost price.

Thus the invention relates to an endless sleeve provided with at least one support of substantially cylindrical shape, whose exterior surface is covered by at least one layer of bonding and permanently adhesive material, the said sleeve being intended to be mounted on a support cylinder, while its exterior surface permits removable fixation of printing plates by adhesion.

Throughout the description, a bonding and permanently adhesive material will be understood as a material whose bonding and adhesive properties are durable in time, typically for a duration of at least 8 to 12 months.

Thus the sleeve according to the invention, after it has been mounted on a support or plateholder cylinder, makes it possible to avoid the use of double-sided adhesive. In fact, the entire exterior surface of the assembly constituted by the cylinder and the sleeve is bonding and permanently adhesive, thus ensuring that printing plates can be fixed directly thereon. Thus a preliminary operation of positioning and fixing a double-sided adhesive is not necessary.

In addition, after their use, the printing plates can be easily removed from the exterior surface of the sleeve for the purpose of later use.

This sleeve has a much lower cost price than that of double-sided adhesives, by virtue of specific production processes.

It may also be noted that the continuity of the sleeve according to the invention makes it possible to eliminate the disadvantages associated with the use of fixation means involving joints. In fact, the presence of joints usually leads to printing flaws and therefore to losses of paper.

Advantageously, the bonding and permanently adhesive material is based on polymers.

Preferably this material is a cross-linked photopolymer.

The total thickness of the bonding and permanently adhesive materials is preferably between 10 and 500 μm (microns).

In addition, the sleeve support according to the invention is advantageously compressible.

The invention also relates to a process for obtaining a sleeve such as described hereinabove, this process comprising:

placing a support of substantially cylindrical shape in an annular coating machine and

activating the said machine to obtain a deposit of at least one layer of bonding and permanently adhesive material.

Preferably the support is disposed vertically in the said machine, which is provided with an annular receptacle containing the said material and disposed around the said support, the support and the receptacle being displaced translationally in relative motion in vertical direction to achieve deposition of the said layer on the support.

In addition, when the deposited material is of the polymeric type, and especially is a photopolymer, the process also comprises achieving cross-linking of the said material.

The invention will be better understood, and other objectives, advantages and characteristics thereof will become clearer, upon reading the description given hereinafter with reference to the attached drawing, wherein

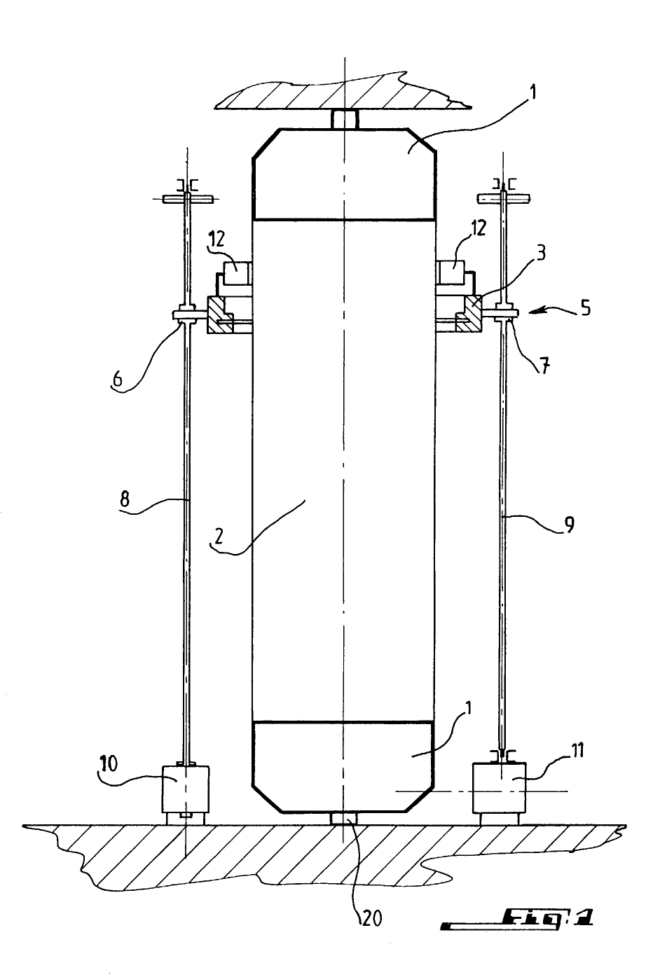

FIG. 1 is a sectional view of an annular and vertical coating machine, and

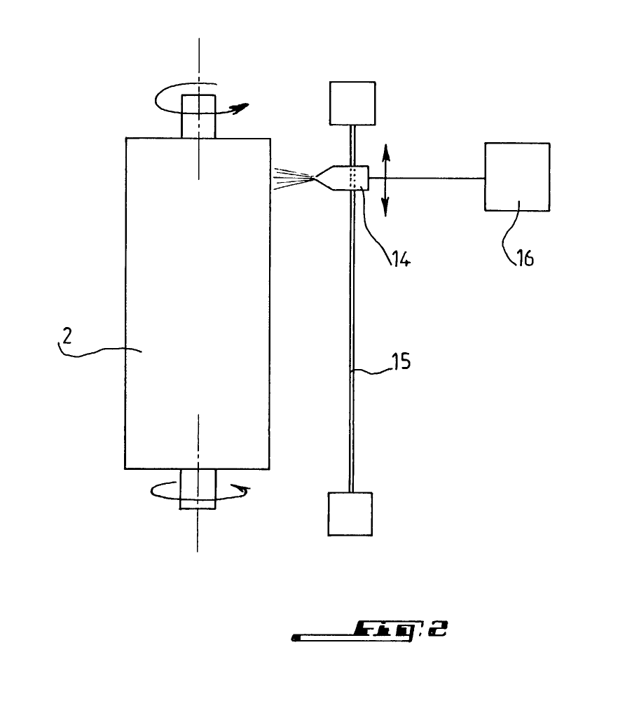

FIG. 2 is a schematic view of a machine for spray application of the material.

Reference symbol 1 denotes the means for holding a substantially cylindrical support 2 in vertical position. These means 1 can in particular comprise a cylinder.

Support 2 is made in particular of a composite material such as an epoxy resin matrix reinforced by fibers.

The machine is also provided with an annular reservoir 3, which contains a bonding and permanently adhesive material.

In the illustrated example, support 2 is fixed and the machine is provided with means 5 associated with receptacle 3 for displacing it vertically or else along axis 20 of support 2.

Of course, it would also be possible to provide a machine with a fixed annular receptacle 3 and means for displacing support 2 along its axis 20.

As an example, the means for translational displacement of annular receptacle 3 have the form of two screws 6, 7 fixed to receptacle 3 in diametrically opposite positions, each of these screws being designed to cooperate with a threaded rod 8, 9. In addition, appropriate means 10, 11 are provided to drive each of these threaded rods 8, 9.

Coating of support 2 is achieved in that drive means 10, 11 of threaded rods 8, 9 are controlled in such a way that annular receptacle 3 is displaced along axis 20, for example from top to bottom.

Annular receptacle 3 is designed to deposit on support 2, in a thickness of between 10 and 250 μm (microns), a layer of bonding and adhesive material that it contains. Of course, it is possible to repeat the operation to increase the total thickness of bonding materials on support 2.

This material is advantageously based on polymers.

Thus it is advisable to cross-link the said material.

It is for this reason that, in the example illustrated in the figure, means 12 are provided to ensure cross-linking of the polymer deposited on support 2.

The following materials can be cited as examples: polymers based on carboxylated nitrile, polyisoprene, acrylate resin, silicone, polychloroprene, ethylene vinyl acetate, butyl and polyurethane.

Cross-linking can be achieved by various means, especially by exposure to UV light in the case of photopolymers, or else by application of heat.

After cross-linking, these materials have bonding character, permitting removable fixation of printing plates, which is characterized by a “bond” or “tack” expressed in g/cm and measured, for example, on a “TELTAK”-type apparatus of MONSANTO using operating procedures that are known in themselves. The “bond” values corresponding to adhesives according to the invention typically lie in a range of about 50 to 500 g/cm.

Within this range of values, a printing plate that had previously been fixed to a support can be removed therefrom without leaving part of the adhesive layer still fixed to the plate.

Of course, it is not imperative that cross-linking of the polymer be achieved in the coating machine itself, although such an operating procedure has obvious advantages.

It may also be noted that the annular coating process makes it possible to apply material layers in relatively fine thickness.

The bonding and permanently adhesive material deposited on support 2 is relatively expensive. Thus the ability to apply relatively fine material layers makes it possible to reduce the cost price of the sleeve according to the invention compared with known fixation means, especially double-sided adhesives.

This is particularly true for the materials of the photopolymer type, whose cost price is relatively high.

Of course, the invention is not limited to the operating procedure just described. Deposition of the bonding and permanently adhesive material could also be achieved by spraying, as in painting, or by any other appropriate means. FIG. 2 schematically illustrates an installation for spraying the bonding and adhesive material on support cylinder Z, which can be maintained in rotation, as indicated by the arrows. Under the influence of a control device 16, the material is sprayed onto the exterior surface of cylinder 2 by a spray head 14 that can be displaced along a guide device 15 extending parallel to the support axis. Such a control device is known in itself and does not have to be further explained in detail.

The processes just described therefore make it possible to obtain a sleeve provided with a support of substantially cylindrical shape having an exterior surface covered with a bonding and permanently adhesive material.

Printing plates can then be fixed at any place on its exterior surface, and this can be achieved directly.

It is therefore no longer necessary to undertake preliminary operations of positioning of fixation means, such as double-sided adhesive tapes.

This therefore considerably reduces the operating time and the operating cost.

In addition, when it is necessary to remove the printing plates, this removal is performed without leaving part of the adhesive fixed on the printing plates. It is therefore unnecessary to undertake a subsequent operation of cleaning the printing plates in order to reuse them.

In addition, the exterior surface of the sleeve does not suffer deterioration, and other printing plates can be fixed removably thereon at a later time.

In the examples described hereinabove, the sleeve is provided with only one layer of bonding and permanently adhesive material. The invention is not limited to this example and, in particular, the sleeve can be provided with different successively applied layers, which may or may not be formed with the same bonding and permanently adhesive material.

The application, during production of the sleeve according to the invention, of a plurality of successive layers on the support may make it possible to obtain a specified thickness or particular performances. In this regard, different materials may be used depending on their physical properties, especially in terms of hardness, chemical resistance or even bonding character.

In addition, the support of the sleeve according to the invention can be made of a compressible material to improve printing quality.

Finally, although only printing plates have been mentioned throughout the description, the sleeve according to the invention could also be used for fixation of photogravure plates, letterpress typeforms, offset plates or diverse films.

The reference symbols appended to the technical characteristics specified in the claims are provided merely to facilitate understanding thereof without limiting the scope thereof.

1. An endless sleeve provided with at least one support (2) of substantially cylindrical shape, whose exterior surface is covered by at least one layer of bonding and permanently adhesive material, applied in the form of an endless layer, the said sleeve being intended to be mounted on a support cylinder, while its exterior surface permits removable fixation of printing plates by adhesion.

2. A sleeve according to claim 1, wherein the bonding and permanently adhesive material is based on polymers.

3. A sleeve according to claim 2, wherein the material is a cross-linked photopolymer.

4. A sleeve according to one of claims 1 to 3, wherein the total thickness of the bonding and permanently adhesive materials is between 10 and 500 μm (microns).

5. A sleeve according to one of claims 1 to 4, whose support is compressible.

6. A process for obtaining a sleeve according to one of claims 1 to 5, comprising making the layer of bonding and permanently adhesive material by application of the bonding and adhesive material on the exterior surface of the support.

7. A process according to claim 6, comprising:
placing a support (2) of substantially cylindrical shape in an annular coating machine and
activating the said machine to obtain a deposit of at least one layer of bonding and permanently adhesive material.

8. A process according to claim 7, wherein the support (2) is disposed vertically, the machine comprising an annular receptacle (3) containing the said material and disposed around the support, the said support and the said receptacle being displaced translationally in relative motion to achieve deposition of the said layer on the support (2).

9. A process according to claim 7 or 8, wherein the material deposited on the support is of the polymeric type, and especially is a photopolymer, the process also comprising achieving cross-linking of the said material.

10. A process according to claim 6, wherein the layer of bonding and adhesive material is obtained by spraying the bonding and adhesive material onto the exterior face of the support.
